(19) United States
(12) Patent Application Publication
(10) Pub. No.: US 2025/0102948 A1
(43) Pub. Date: Mar. 27, 2025

(54) IMAGE FORMING APPARATUS AND NON-TRANSITORY COMPUTER READABLE MEDIUM

(71) Applicant: FUJIFILM Business Innovation Corp., Tokyo (JP)

(72) Inventor: Yu TSUDA, Kanagawa (JP)

(21) Appl. No.: 18/430,020

(22) Filed: Feb. 1, 2024

(30) Foreign Application Priority Data
Sep. 26, 2023 (JP) 2023-163142

(51) Int. Cl. G03G 15/05; G03G 15/06

(52) U.S. Cl. CPC G03G 15/052; G03G 15/06

(57) ABSTRACT

An image forming apparatus includes a first image former that, after charging a first image holder, forms an image on the first image holder by attaching a developer onto the first image holder; a second image former that, after charging a second image holder, forms an image on the second image holder by attaching a developer onto the second image holder; and a processor that is configured to set, in accordance with information on at least one of the developer used on the first image former and the developer used on the second image former, a first charging condition of the first image former including a first frequency of the first image former and is configured to set a second charging condition serving as a charging condition of the second image former and including a second frequency different from the first frequency.

### CROSS-REFERENCE TO RELATED APPLICATIONS

This application is based on and claims priority under 35 USC 119 from Japanese Patent Application No. 2023-163142 filed Sep. 26, 2023.

### BACKGROUND

### (i) Technical Field

The present disclosure relates to an image forming apparatus and a non-transitory computer readable medium.

### (ii) Related Art

Japanese Unexamined Patent Application Publication No. 2006-50347 discloses an image forming apparatus that is enabled to form an image using process color toner and metallic toner. The image forming apparatus includes a metallic color converter, process color converter, screen unit and image former. The metallic color converter converts a metallic color of input image data into a metallic color signal that is used to form an image using the process color toner and metallic toner. The process color converter converts the input image data excluding the metallic color into a process color signal that is used to form an image using the process color toner. The screen unit performs a screen process on the metallic color signal obtained by the metallic color converter or the process color signal obtained by the process color converter. In accordance with the process color signal or the metallic color signal, after having undergone the screen process, the image former forms an image using the process color toner and the metallic toner. The screen unit performs on the metallic color signal the screen process different from the screen process applied to the process color signal.

### SUMMARY

In an image forming apparatus including a first image former that, after charging a first image holder, forms an image on the first image holder by attaching a developer onto the first image holder and a second image former that, after charging a second image holder, forms an image on the second image holder by attaching a developer onto the second image holder, interference between images may occur depending on a combination of developers. In order to control such interference, a modification, if made in screen angles and screen line counts included in the first charging condition of the first image former and the second charging condition of the second image former, may lead to narrowing a selection range of the charging condition.

Aspects of non-limiting embodiments of the present disclosure relate to widening a selection range of a charging condition in comparison with the case where image interference is controlled by modifying a screen angle and a screen line count as a charging condition.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a first image former that, after charging a first image holder, forms an image on the first image holder by attaching a developer onto the first image holder; a second image former that, after charging a second image holder, forms an image on the second image holder by attaching a developer onto the second image holder; and a processor that is configured to set, in accordance with information on at least one of the developer used on the first image former and the developer used on the second image former, a first charging condition of the first image former including a first frequency of the first image former and set a second charging condition serving as a charging condition of the second image former and including a second frequency different from the first frequency.

### BRIEF DESCRIPTION OF THE DRAWINGS

Exemplary embodiments of the present disclosure will be described in detail based on the following figures, wherein:

FIG. 1 illustrates an image forming apparatus;

FIG. 2 illustrates a hardware configuration of a controller in the image forming apparatus;

FIG. 3 schematically illustrates image forming performed by the image forming apparatus;

FIG. 4 is a flowchart illustrating a process flow including setting of a charging condition;

FIGS. 5A and 5B illustrate image forming according to a first exemplary embodiment, wherein FIG. 5A illustrates a charging condition and FIG. 5B illustrates an image developed through the image forming;

FIGS. 6A and 6B illustrate the image forming according to a second exemplary embodiment, wherein FIG. 6A illustrates a charging condition and FIG. 6B illustrates an image developed through the image forming; and

FIGS. 7A and 7B illustrate the image forming according to a third exemplary embodiment, wherein FIG. 7A illustrates a charging condition and FIG. 7B illustrates an image developed through the image forming.

### DETAILED DESCRIPTION

Exemplary embodiments of the disclosure are described below in detail with reference to the drawings.

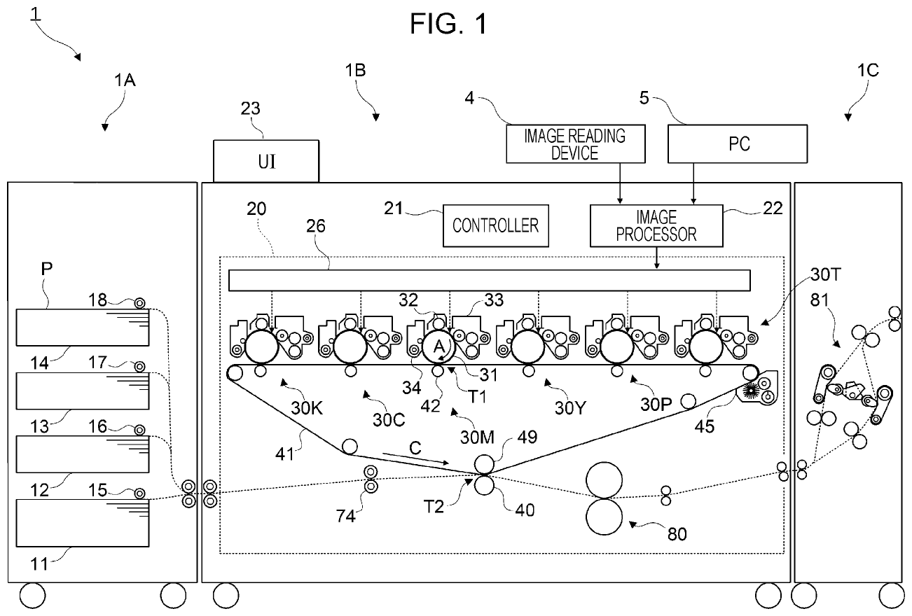

FIG. 1 illustrates an image forming apparatus 1.

The image forming apparatus 1 of the exemplary embodiments includes a paper feeder module 1A, printing module 1B and copy receiving module 1C.

The paper feeder module 1A includes first paper trays 11 through fourth paper tray 14 containing paper sheets P serving as an example of a recording medium.

The paper feeder module 1A includes paper feed rollers 15 through 18 that are respectively arranged for the first paper tray 11 through fourth paper tray 14 and feed paper sheets P contained in the paper trays to a transport path connected to the printing module 1B.

The printing module 1B includes an image former 20 that forms an image on a paper sheet P. The printing module 1B also includes the controller 21 that controls elements of the image forming apparatus 1.

The printing module 1B includes an image processor 22. The image processor 22 performs image processing on image data transmitted from an image reading device 4 or a personal computer (PC) 5.

The printing module 1B includes a touch panel and a user interface (UI) 23 that notifies a user of information and receives information from the user.

The image former 20 includes six image forming units 30T, 30P, 30Y, 30M, 30C and 30K (hereinafter occasionally simply referred to as an “image forming unit 30”) that are arranged in parallel with fixed space intervals therebetween.

Each image forming unit 30 includes a photoconductor drum 31 that rotates in the direction denoted by an arrow A with a latent image formed thereon, charging roller 32 that charges the surface of the photoconductor drum 31, developing part 33 that develops an image from the latent image formed on the photoconductor drum 31 and a drum cleaner 34 that removes toner and the like from the surface of the photoconductor drum 31.

The image former 20 also includes a laser exposure device 26 that exposes to laser light the photoconductor drum 31 of each image forming unit 30.

The light exposure of the photoconductor drum 31 using the laser exposure device 26 is not limited to laser light. For example, each image forming unit 30 may include a light source, such as a light emitting diode (LED), and the photoconductor drum 31 may be exposed to light emitted from the light source.

The image forming units 30 are identical in configuration to each other except toner contained in the developing part 33. The image forming units 30Y, 30M, 30C and 30K respectively form yellow (Y), magenta (M), cyan (C) and black (K) toner images.

The image forming units 30T and 30P form toner images using toner corresponding to a corporate color, foaming toner for braille, fluorescent toner and toner enhancing gloss. In other words, the image forming units 30T and 30P form toner images using special color toner.

The image former 20 also includes an intermediate transfer belt 41 to which the toner images of the colors formed on the photoconductor drums 31 of the image forming units 30 are transferred.

The image former 20 further includes first transfer rollers 42 that transfer the toner images of the colors of the image forming units 30 to the intermediate transfer belt 41 at first transfer sections T1.

The image former 20 further includes a second transfer roller 40 that transfers at a time a toner image on the intermediate transfer belt 41 to the paper sheet P at a second transfer section T2.

The image former 20 further includes a belt cleaner 45 that removes the toner and the like on the surface of the intermediate transfer belt 41 and a fixing device 80 that fixes the second-transferred image onto the paper sheet P.

The image former 20 performs an image forming operation in accordance with a control signal from the controller 21.

Specifically, in the image former 20, the image processor 22 performs the image processing operation on image data input from the image reading device 4 or PC 5 and supplies the processed image data to the laser exposure device 26.

With the surface of the photoconductor drum 31 in the magenta (M) image forming unit 30M charged with the charging roller 32, the laser exposure device 26 irradiates the photoconductor drum 31 with image-data-modulated laser light that is received from the image processor 22.

A latent image is thus formed on the photoconductor drum 31.

The latent image thus formed is developed by the developing part 33 into a magenta toner image on the photoconductor drum 31.

Similarly, yellow, cyan and black toner images are respectively formed on the image forming units 30Y, 30C and 30K and the special color toner images are formed on the image forming units 30T and 30P.

The toner images formed on the image forming units 30 are successively electrostatically transferred to the intermediate transfer belt 41 moving in the direction of the arrow C in FIG. 1 by the first transfer rollers 42, leading to a toner image superimposed on the intermediate transfer belt 41.

With the intermediate transfer belt 41 moving, the toner image superimposed on the intermediate transfer belt 41 is transported to the second transfer section T2 including the second transfer roller 40 and backup roller 49.

The paper sheet P is picked up from the first paper tray 11 by a feeder roller 15 and then transported along the transport path to the position of a paper stop roller 74.

When the superimposed toner image reaches the second transfer section T2, the paper sheet P is transported to the second transfer section T2 from the paper stop roller 74.

The effect of a transfer electric field created at the second transfer section T2 between the second transfer roller 40 and backup roller 49 causes the superimposed toner image to be electrostatically transferred to the paper sheet P.

The paper sheet P having the superimposed toner image transferred thereto is transported to the fixing device 80.

The fixing device 80 presses and heats the paper sheet P having the unfixed toner image, thereby performing a fixing operation to fix the toner image onto the paper sheet P.

The paper sheet P having undergone the fixing operation is transported via a curl correction section 81 in the copy receiving module 1C and then discharged into a paper receiving tray (not illustrated).

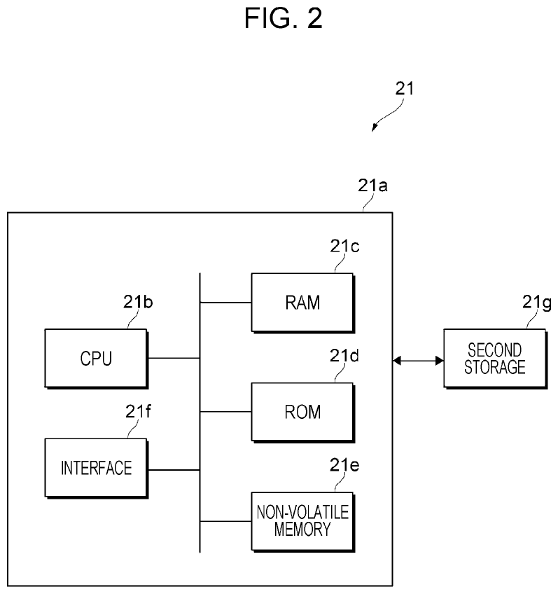

FIG. 2 illustrates a hardware configuration of the controller 21 in the image forming apparatus 1. The controller 21 in the image forming apparatus 1 is implemented by a computer.

The controller 21 includes an arithmetic processing unit 21a that performs a digital arithmetic processing operation in accordance with a program and a second storage 21g that stores information.

The second storage 21g may be an available information storage device, such as a hard disk drive (HDD), semiconductor memory, magnetic tape or the like.

The arithmetic processing unit 21a includes a central processing unit (CPU) 21b as a processor.

The arithmetic processing unit 21a also includes a random-access memory (RAM) 21c that is used as a working memory for the CPU 21b and read-only memory (ROM) 21d that stores a program and the like performed by the CPU 21b.

The arithmetic processing unit 21a further includes a non-volatile memory 21e that is configured to be re-writable and continues to store data even when power supplying is interrupted and an interface 21f that controls a communicator connected to the arithmetic processing unit 21a.

The non-volatile memory 21e includes a static RAM backed up by a battery or a flash memory. The second storage 21g stores not only files but also a program executed by the arithmetic processing unit 21a.

According to the exemplary embodiments, the arithmetic processing unit 21a performs operations by reading programs stored on the ROM 21d or the second storage 21g.

The programs to be executed by the CPU 21b may be delivered in a recorded form on one of computer readable recording media including a magnetic recording medium (such as a magnetic tape or magnetic disk), optical recording medium (such as an optical disk), magneto-optical recording medium or semiconductor memory. The programs to be executed by the CPU 21b may also be delivered to the image forming apparatus 1 using a communication medium, such as the Internet.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the embodiments below, and may be changed.

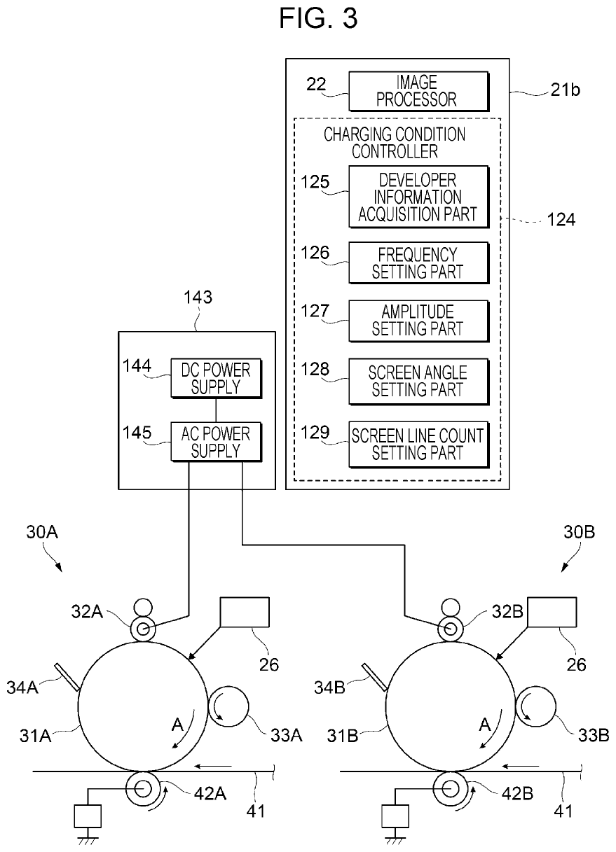

FIG. 3 schematically illustrates image forming performed by the image forming apparatus 1. The image forming units 30A and 30B are any two ones of the six image forming units 30T, 30P, 30Y, 30M, 30C and 30K (see FIG. 1) included in the image forming apparatus 1 described above. The six image forming units 30T, 30P, 30Y, 30M, 30C and 30K are basically identical to each other and, for convenience of explanation, elements are denoted by symbols to indicate which of the elements correspond to those of the image forming unit 30A or 30B. Specifically, the symbol of each element in the image forming unit 30A is suffixed with “A” and the symbol of each element in the image forming unit 30B is suffixed with “B.” Elements described above with reference to FIG. 1 may not be illustrated in FIG. 3 or may not be described again.

According to the exemplary embodiments, referring to FIG. 3, the image forming unit 30A is one of the image forming units 30Y, 30M, 30C and 30K and the image forming unit 30B is one of the image forming units 30T and 30P. Specifically, the image forming unit 30A performs image forming using developers of yellow, magenta, cyan and black (YMCK) colors and the image forming unit 30B performs image forming using special color developers. The disclosure is not limited to this configuration.

The image forming unit 30A is an example of a first image former and the image forming unit 30B is an example of a second image former. The photoconductor drum 31A of the image forming unit 30A is an example of a first image holder and the photoconductor drum 31B of the image forming unit 30B is an example of a second image holder. The developer of one of the YMCK colors is an example of a developer used in the first image former and the developer of the special color is a developer used in the second image former.

Referring to FIG. 3, the image forming unit 30A includes a charging roller 32A arranged on the circumference of the photoconductor drum 31A rotating in the direction denoted by an arrow A, developing device 33A and drum cleaner 34A. The laser exposure device 26 exposes to light the photoconductor drum 31A charged by the charging roller 32A and forms a latent image on the photoconductor drum 31A. The toner image developed on the photoconductor drum 31A by the developing device 33A is transferred to the intermediate transfer belt 41 by a first transfer roller 42A.

The image forming unit 30B includes a charging roller 32B arranged on the circumference of the photoconductor drum 31B rotating in the direction denoted by the arrow A, developing device 33B and drum cleaner 34B. The laser exposure device 26 exposes to light the photoconductor drum 31B charged by the charging roller 32B and forms a latent image on the photoconductor drum 31B. The toner image developed on the photoconductor drum 31B by the developing device 33B is transferred to the intermediate transfer belt 41 by a first transfer roller 42B.

A power supply 143 includes a direct current (DC) power supply 144 and an alternating current (AC) power supply 145. The power supply 143, controlled by the CPU 21b (see also FIG. 2), applies to each of the charging rollers 32A and 32B a voltage in which a DC voltage and AC voltage are superimposed and also applies voltages in use to the developing devices 33A and 33B and the first transfer rollers 42A and 42B. The power supply 143 also applies a voltage to the second transfer roller 40 (see FIG. 1).

A cleaning roller is arranged opposed to and in contact with each of the charging rollers 32A and 32B.

Referring to FIG. 3, the CPU 21b includes a charging condition controller 124 that sets a charging condition of the charging roller 32A and a charging condition of the charging roller 32B.

The charging condition controller 124 includes a developer information acquisition part 125, frequency setting part 126, amplitude setting part 127, screen angle setting part 128 and screen line count setting part 129.

In response to a print instruction including the image data and transmitted from the image reading device 4 or PC 5 (see FIG. 1), the developer information acquisition part 125 acquires developer information indicating developers used in the image forming units 30A and 30B.

For example, the developer information acquisition part 125 acquires, as the developer information, information indicating whether a special color developer in addition to the YMCK colored developers as basic colors is used. If the special color developer is used, the developer information acquisition part 125 also acquires, as the developer information, information indicating which special color developer is used.

If the special color developer is used, the developer information acquisition part 125 further acquires, as the developer information, information indicating a relationship with the YMCK color developers, for example, information as to whether the special color developer and the YMCK color developers are of similar color. The developer information acquisition part 125 further acquires, as the developer information, information indicating whether there is a difference in color between the YMCK color and the special color.

The developer information acquired by the developer information acquisition part 125 is not limited to information on developers used in the image forming units 30A and 30B. Specifically, the developer information may include only one piece of information on the developer used in the image forming unit 30A and information on the developer used in the image forming unit 30B. For example, the developer information does not include the information on the developer used in the image forming unit 30A but includes the information on the developer used in the image forming unit 30B.

The frequency setting part 126, amplitude setting part 127, the screen angle setting part 128 and screen line count setting part 129 set a charging condition on the charging rollers 32A and 32B in accordance with the developer information acquired by the developer information acquisition part 125.

The charging condition indicates a frequency and amplitude of the superimposed voltage during charging, screen angle and screen line count.

Specifically, the frequency setting part 126 sets the frequency of the voltage applied to the charging roller 32A and the frequency of the voltage applied to the charging roller 32B. The amplitude setting part 127 sets the amplitude of the voltage applied to the charging roller 32A and the amplitude of the voltage applied to the charging roller 32B.

The screen angle setting part 128 sets the screen angle of the charging roller 32A and the screen angle applied to the charging roller 32B. The screen line count setting part 129 sets the screen line count of the charging roller 32A and the screen line count of the charging roller 32B.

According to the exemplary embodiments, the charging conditions of the image forming units 30A and 30B are set in accordance with the developer information but the disclosure is not limited to this method.

For example, it is contemplated that a predetermined charging condition is set to the image forming unit 30A while a charging condition is set in accordance with the developer information on the image forming unit 30B.

It is also contemplated that the predetermined charging condition is set to one or both of the image forming unit 30A and the image forming unit 30B depending on the developer information. Specifically, the charging condition is switched depending on the developer in use.

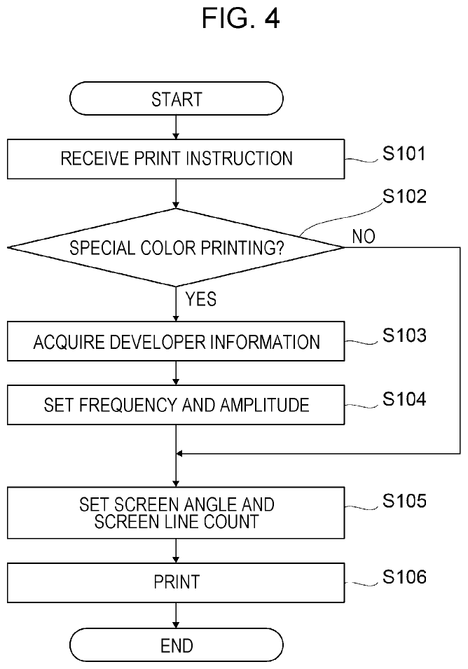

FIG. 4 is a flowchart illustrating a process flow that sets the charging condition.

Referring to FIG. 4, in response to the reception of a print instruction including the image data transmitted from the image reading device 4 or the PC 5 (see FIG. 1) in step S101, the developer information acquisition part 125 determines whether the print instruction indicates the user of a special color developer (step S102).

If the print instruction indicates the use of the special color developer (yes in step S102), the developer information acquisition part 125 (see FIG. 3) acquires the developer information in the print instruction (step S103).

The frequency setting part 126 and amplitude setting part 127 (see FIG. 3) set the frequencies and amplitudes in accordance with the acquired developer information (step S104) and the screen angle setting part 128 and screen line count setting part 129 (see FIG. 3) set the screen angles and screen line counts (step S105).

Charging is thus performed in accordance with the frequencies, amplitudes, screen angles and screen line counts set as the charging conditions on the image forming units 30A and 30B and printing is thus performed (step S106).

On the other hand, if the print instruction does not indicate the use of the special color developer (no in step S102), the screen angle setting part 128 and screen line count setting part 129 (see FIG. 3) respectively set the screen angle and screen line count (step S105), charging is performed in accordance with the screen angle and screen line count set as the charging condition on the image forming unit 30A and printing is thus performed (step S106).

A setting example with the charging condition under which special color printing is performed (yes in step S102) is described. The following discussion is based on condition that the image forming unit 30A (see FIG. 3) performs image forming using the YMCK color developers and the image forming unit 30B (see FIG. 3) performs image forming using the special color developer.

### First Setting Example

The frequencies as the charging conditions of the image forming units 30A and 30B are different from each other. Specifically, the frequency of the image forming unit 30A is higher than the frequency of the image forming unit 30B or the frequency of the image forming unit 30B is higher than the frequency of the image forming unit 30A. Increasing the frequency widens a selection range of the charging condition including a screen, such as a binary screen of 1200 dots per inch (dpi).

The charging condition of the image forming unit 30A is an example of a first charging condition and the frequency of the image forming unit 30A is an example of a first frequency. The charging condition of the image forming unit 30B is an example of a second charging condition and the frequency of the image forming unit 30B is an example of a second frequency.

It is contemplated in a first setting example that one of the frequencies of the image forming units 30A and 30B is an integer multiple of the other of the frequencies of the image forming units 30A and 30B. In this way, it is easy to produce a higher screen count of a screen. For example, the integer multiple may be twice or three times.

### Second Setting Example

The frequency of the image forming unit 30B may be an integer multiple of the frequency of the image forming unit 30A.

If the developer of the image forming unit 30B is a special color developer, such as a golden or silver developer having a lower friction rate, in the second setting example it is contemplated that the frequency of the image forming unit 30B is set to be higher than the frequency of the image forming unit 30A. In this way, friction of the photoconductor drum 31B is increased and deletion, namely, the occurrence of image blanking may be controlled.

It is also contemplated that the frequency of the image forming unit 30B is set to be higher than the frequency of the image forming unit 30A or the amplitude of the image forming unit 30B is set to be wider than the amplitude of the image forming unit 30A.

The developer of the image forming unit 30B having a lower friction rate is an example of a predetermined condition.

### Third Setting Example

The screen line count as the charging condition of the image forming unit 30B may be set to be higher than the screen line count as the charging condition of the image forming unit 30A. A third setting example herein may be used together with the first setting example. In this way, the friction of the photoconductor drum 31B may be increased and the deletion may be controlled.

### Fourth Setting Example

The frequency of the image forming unit 30B may be an integer multiple of the frequency of the image forming unit 30A and the screen angle of the image forming unit 30A may be set to be equal to the screen angle of the image forming unit 30B. In this way, image interference, namely, more interference may be controlled.

In a fourth setting example, herein, the developer of the image forming unit 30A and the developer of the image forming unit 30B may be of similar colors. The similar colors refer to colors adjacent or closer to each other in the color wheel and, for example, refers to the developer of the image forming unit 30B having a lighter one of the YMCK colors. Also, for example, the similar colors refer to the developer of the image forming unit 30B having a fluorescent pink color with respect to the M color. In this way, more interference may be more controlled.

In the fourth setting example, the developer of the image forming unit 30B may be lighter in color than the developer of the image forming unit 30A. For example, the developer of the image forming unit 30A may be a lighter one of the YMCK colors and the developer of the image forming unit 30B may be a lighter color, for example, pink.

### Fifth Setting Example

If the developer of the image forming unit 30B is lighter in color than the developer of the image forming unit 30A in the fourth setting example, the screen line count of the image forming unit 30B may be higher than the screen line count of the image forming unit 30A. For example, the screen line count of the image forming unit 30B may be twice as high as the screen line count of the image forming unit 30A.

### Sixth Setting Example

It is contemplated that the fourth setting example is employed if the developer of the image forming unit 30A is a color of a higher frequency of use of the YMCK colors. For example, a color having a higher frequency of use may be the K color. It is contemplated more in detail that the special color, such as pink, of the developer of the image forming unit 30B is set to be equal in screen angle to the K color and the frequency of the image forming unit 30A is set to be lower than the frequency of the image forming unit 30B. In this way, the friction of the photoconductor drum 31A in the image forming unit 30A may be controlled.

It is further contemplated that the screen line count of the image forming unit 30A is equalized to the screen line count of the image forming unit 30B. Specifically, the special color, such as pink, of the developer of the image forming unit 30B is set be equal in screen line count to one of the YMCK colors.

A variety of screens under the charging condition are specifically described below.

### First Exemplary Embodiment

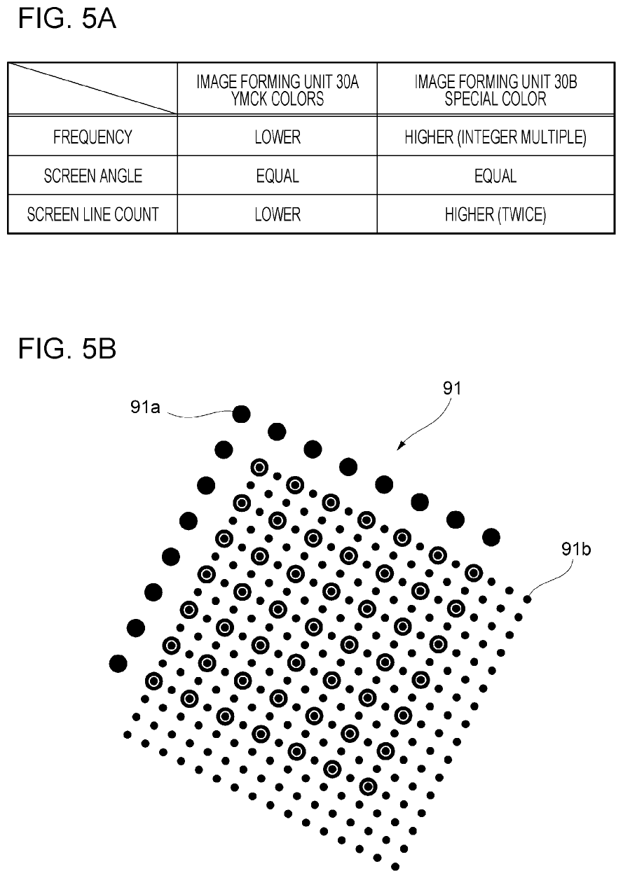

FIGS. 5A and 5B illustrate image forming according to a first exemplary embodiment. FIG. 5A illustrates a charging condition and FIG. 5B illustrates an image 91 developed through the image forming.

According to the first exemplary embodiment, an image is formed by superimposing a deeper color of the YMCK colors and a lighter color as a special color. Specifically, there is a difference in shading of similar colors between the developer of the image forming unit 30A and the developer of the image forming unit 30B. As an example, the image forming unit 30A has the M color and the image forming unit 30B has a fluorescent pink color as a special color.

Image forming is performed under the charging condition illustrated in FIG. 5A in the above example.

The frequency of the image forming unit 30B is higher than and an integer multiple of the frequency of the image forming unit 30A. The screen angle of the image forming unit 30B is equal to the screen angle of the image forming unit 30A having the M color. The screen line count of the image forming unit 30B is twice as high as the screen line count of the image forming unit 30A having the M color.

According to the first exemplary embodiment, the special color being fluorescent pink has a frequency equal to an integer multiple of each of the YMCK colors, is equal in screen angle to a deeper M color similar to the special color and has twice as high as the screen line count of the deeper M color. The first exemplary embodiment thus forms an image having a lighter special color.

If image forming is performed under such the charging condition with similar colors having a difference in shading superimposed, the image 91 results as illustrated in FIG. 5B. The image 91 includes M color dots 91a and fluorescent pink dots 91b.

According to the principle of the first exemplary embodiment, as the screen line count is higher, a latent image becomes lighter and the dots become unstable and thus a thick dot may be typically produced by a lower line count to improve a granular shape thereof. As a charge frequency is higher, uneven charging or ripple becomes smaller in a paper transport direction and a higher line count is easier to produce. On the other hand, if a spatial frequency is higher, friction increases in response to an increase in the number of discharging of AC and thus charging frequency of basic colors such as the YMCK colors is thus set to be lower.

Since the image forming is performed in this way using the special color (fluorescent pink) having the same angle as the M color and the screen line count twice as high as the screen line count of the M color, the occurrence of more interference may be controlled even with the special color superimposed on the human skin.

### Second Exemplary Embodiment

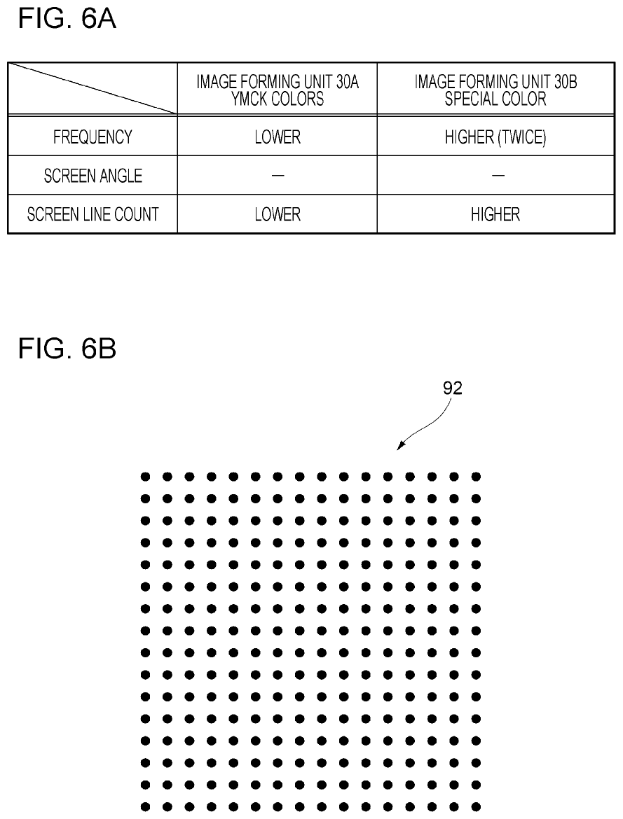

FIGS. 6A and 6B illustrate the image forming according to a second exemplary embodiment. FIG. 6A illustrates a charging condition and FIG. 6B illustrates an image 92 developed through the image forming.

The second exemplary embodiment illustrated in FIGS. 6A and 6B performs image forming by superimposing the special color, such as a golden color, having a larger particle size. Specifically, the developer of the image forming unit 30B is a golden developer or silver developer, having a lower friction rate.

Image forming is performing using the charging condition illustrated in FIG. 6A in the second embodiment.

The frequency of the image forming unit 30B is higher, specifically, twice as high as the frequency of the image forming unit 30A. The screen line count of the image forming unit 30B is higher than the screen line count of the image forming unit 30A.

If image forming is performed by superimposing the special color, such as the golden or silver color, having the lower friction rate in the second exemplary embodiment, the charging condition is that the special color is higher in screen line count than the YMCK colors and higher in charge frequency than the YMCK colors.

It is also contemplated that the frequency of the special color is set to be higher or alternatively the amplitude of the special color is set to be increased.

If image forming is performed under the charging condition by superimposing the special color, such as a golden or silver color, having a lower friction rate, the image 92 illustrated in FIG. 6B may result.

According to the principle of the second exemplary embodiment, the friction rate is typically lower because the golden or silver toner contains aluminum pieces and thus has a larger toner particle size, toner particles are less likely to coalesce in a toner accumulation. Since the golden or silver toner is used in a two-tone fashion of 100% and 0% with no intermediate tone therebetween, a latent image is formed using a line count as high as 1200 dpi without any problem. Deletion may be controlled by charging at a higher frequency and increasing a friction rate.

The developer of the special color originally having a lower friction rate may be increased in friction rate by increasing the charge frequency and image deletion may also be controlled at the same time.

### Third Exemplary Embodiment

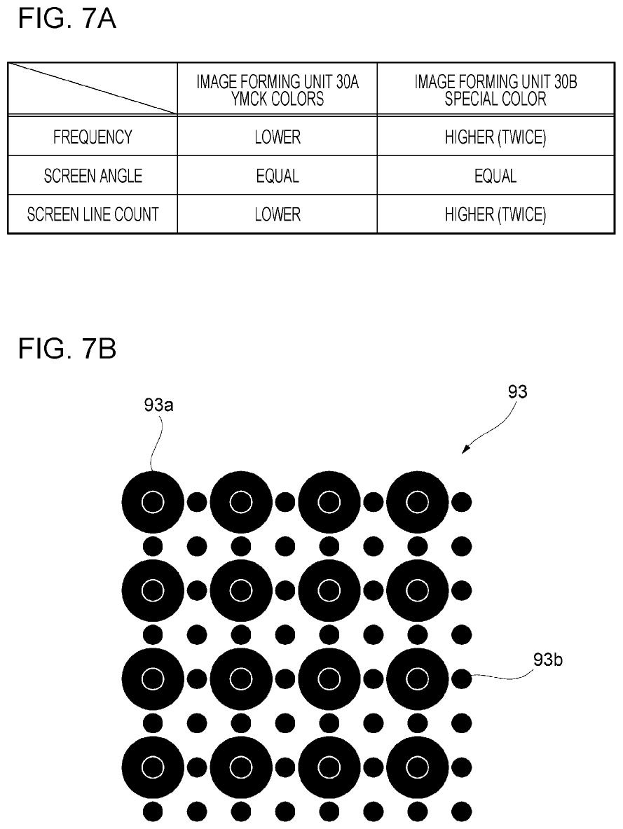

FIGS. 7A and 7B illustrate the image forming according to a third exemplary embodiment. FIG. 7A illustrates a charging condition and FIG. 7B illustrates an image 93 developed through the image forming.

According to the third exemplary embodiment, image forming is performed by superimposing a deeper one of the YMCK colors, for example, M color, and a special color, for example, pink, which is lighter and similar to the deeper color.

Image forming is performing using the charging condition illustrated in FIG. 7A in the third embodiment.

The frequency of the image forming unit 30B is higher, specifically, twice as high as the frequency of the image forming unit 30A. The screen angle of the image forming unit 30A is equal to the screen angle of the image forming unit 30B. The screen line count of the image forming unit 30B is twice as high as the screen line count of the image forming unit 30A.

If pink or any other special color is superimposed on one of the YMCK colors with the same screen line count and the same screen angle applied, image forming is performed under the charging condition that the frequency and the screen line count of the one of the YMCK colors are halved.

If image forming is performed under the charging condition by superimposing the special color on one of the YMCK colors, the image 93 illustrated in FIG. 7B may result. The image 93 incudes dots 93a having one of the YMCK colors and pink dots 93b. The principle of the third exemplary embodiment is identical to the principle of the first exemplary embodiment and the discussion thereof is omitted herein.

If one of the YMCK colors having a higher frequency of use is the K color, a K color version with pink having the same screen line count and the same screen angle as the K color is likely to have more interference in an intermediate tone. Gradation may be lowered by reducing the frequency and screen line count to control the more interference and in particular to reduce the friction rate of the K color.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

Appendix

(((1)))

An image forming apparatus including:
a first image former that, after charging a first image holder, forms an image on the first image holder by attaching a developer onto the first image holder;
a second image former that, after charging a second image holder, forms an image on the second image holder by attaching a developer onto the second image holder; and
a processor that is configured to set, in accordance with information on at least one of the developer used on the first image former or the developer used on the second image former, a first charging condition of the first image former including a first frequency of the first image former and a second charging condition serving as a charging condition of the second image former and including a second frequency different from the first frequency.
   (((2)))

In the image forming apparatus according to (((1))), one of the first frequency and the second frequency is an integer multiple of the other of the first frequency and the second frequency.

(((3)))

In the image forming apparatus according to (((2))), the second frequency is higher than the first frequency.

(((4)))

In the image forming apparatus according to (((3))), the second frequency is set to be higher if the developer of the second image former satisfies a predetermined condition.

(((5)))

In the image forming apparatus according to (((3))), an amplitude of the second frequency is set to be larger if the developer of the second image former satisfies a predetermined condition.

(((6)))

In the image forming apparatus according to one of (((1))) through (((5))), a screen line count included in the second charging condition is higher than a screen line count included in the first charging condition.

(((7)))

In the image forming apparatus according to (((1))), the second frequency is an integer multiple of the first frequency, and
wherein a screen angle included in the first charging condition is equal to a screen angle included in the second charging condition.
   (((8)))

In the image forming apparatus according to (((7))), the developer of the first image former and the developer of the second image former are of similar colors.

(((9)))

In the image forming apparatus according to (((8))), the developer of the second image former is lighter in color than the developer of the first image former.

(((10)))

In the image forming apparatus according to one of (((8))) and (((9))), a screen line count included in the second charging condition is higher than a screen line count included in the first charging condition.

(((11)))

In the image forming apparatus according to (((7))), the developer of the first image former has a color of a higher frequency of use from among yellow, magenta, cyan and black (YMCK) colors.

(((12)))

In the image forming apparatus according to one of (((1))) through (((11))), the developer of the first image former has one of yellow, magenta, cyan and black (YMCK) colors, and
wherein the developer of the second image former has a color other than the YMCK colors.
   (((13)))

An image forming apparatus including:
a first image former that, after charging a first image holder, forms an image on the first image holder by attaching a developer onto the first image holder; and
a second image former that, after charging a second image holder, forms an image on the second image holder by attaching a developer onto the second image holder,
wherein in accordance with information on at least one of the developer used on the first image former and the developer used on the second image former, charging is performed under a first charging condition of the first image former including a first frequency of the first image former and charging is performed under a second charging condition serving as a charging condition of the second image former and including a second frequency different from the first frequency.
   (((14)))

A program causing a computer to execute a process, the computer included in an image forming apparatus including a first image former that, after charging a first image holder, forms an image on the first image holder by attaching a developer onto the first image holder and a second image former that, after charging a second image holder, forms an image on the second image holder by attaching a developer onto the second image holder, the process including:
acquiring information on at least one of the developer used on the first image former and the developer used on the second image former; and
setting a first charging condition of the first image former including a first frequency of the first image former and a second charging condition serving as a charging condition of the second image former and including a second frequency different from the first frequency.

What is claimed is:

1. An image forming apparatus comprising:
a first image former that, after charging a first image holder, forms an image on the first image holder by attaching a developer onto the first image holder;
a second image former that, after charging a second image holder, forms an image on the second image holder by attaching a developer onto the second image holder; and
a processor that is configured to set, in accordance with information on at least one of the developer used on the first image former or the developer used on the second image former, a first charging condition of the first image former including a first frequency of the first image former and a second charging condition serving as a charging condition of the second image former and including a second frequency different from the first frequency.

2. The image forming apparatus according to claim 1, wherein one of the first frequency and the second frequency is an integer multiple of the other of the first frequency and the second frequency.

3. The image forming apparatus according to claim 2, wherein the second frequency is higher than the first frequency.

4. The image forming apparatus according to claim 3, wherein the second frequency is set to be higher if the developer of the second image former satisfies a predetermined condition.

5. The image forming apparatus according to claim 3, wherein an amplitude of the second frequency is set to be larger if the developer of the second image former satisfies a predetermined condition.

6. The image forming apparatus according to claim 1, wherein a screen line count included in the second charging condition is higher than a screen line count included in the first charging condition.

7. The image forming apparatus according to claim 1, wherein the second frequency is an integer multiple of the first frequency, and
wherein a screen angle included in the first charging condition is equal to a screen angle included in the second charging condition.

8. The image forming apparatus according to claim 7, wherein the developer of the first image former and the developer of the second image former are of similar colors.

9. The image forming apparatus according to claim 8, wherein the developer of the second image former is lighter in color than the developer of the first image former.

10. The image forming apparatus according to claim 8, wherein a screen line count included in the second charging condition is higher than a screen line count included in the first charging condition.

11. The image forming apparatus according to claim 9, wherein a screen line count included in the second charging condition is higher than a screen line count included in the first charging condition.

12. The image forming apparatus according to claim 7, wherein the developer of the first image former has a color of a higher frequency of use from among yellow, magenta, cyan and black (YMCK) colors.

13. The image forming apparatus according to claim 1, wherein the developer of the first image former has one of yellow, magenta, cyan and black (YMCK) colors, and
wherein the developer of the second image former has a color other than the YMCK colors.

14. An image forming apparatus comprising:
a first image former that, after charging a first image holder, forms an image on the first image holder by attaching a developer onto the first image holder; and
a second image former that, after charging a second image holder, forms an image on the second image holder by attaching a developer onto the second image holder,
wherein in accordance with information on at least one of the developer used on the first image former or the developer used on the second image former, charging is performed under a first charging condition of the first image former including a first frequency of the first image former and charging is performed under a second charging condition serving as a charging condition of the second image former and including a second frequency different from the first frequency.

15. A non-transitory computer readable medium storing a program causing a computer to execute a process, the computer included in an image forming apparatus including a first image former that, after charging a first image holder, forms an image on the first image holder by attaching a developer onto the first image holder and a second image former that, after charging a second image holder, forms an image on the second image holder by attaching a developer onto the second image holder, the process comprising:
acquiring information on at least one of the developer used on the first image former or the developer used on the second image former; and
setting a first charging condition of the first image former including a first frequency of the first image former and a second charging condition serving as a charging condition of the second image former and including a second frequency different from the first frequency.
